(19) United States
(12) Patent Application Publication
(10) Pub. No.: US 2026/0078206 A1
(43) Pub. Date: Mar. 19, 2026

(54) SOLVENT MANAGEMENT VIA TWO-PHASE ETHYLENE FEED TO SECOND REACTOR TO INCREASE ETHYLENE-BASED POLYMER OUTPUT

(71) Applicant: Dow Global Technologies LLC, Midland, MI (US)

(72) Inventors: Pradeep Jain, Missouri City, TX (US); Alec Y. Wang, Sugar Land, TX (US); Anthony J. Castelluccio, Lake Jackson, TX (US); Curvel Hypolite, West Chester, PA (US); Michael J. Zogg, Jr., Houston, TX (US); Smita Agrawal, Lake Jackson, TX (US); Douglas S. Ginger, Houston, TX (US)

(73) Assignee: Dow Global Technologies LLC, Midland, MI (US)

(21) Appl. No.: 19/108,887

(22) PCT Filed: Sep. 6, 2023
(86) PCT No.: PCT/US2023/073520

§ 371 Date: Mar. 5, 2025

Related U.S. Application Data
(60) Provisional application No. 63/404,744, filed on Sep. 8, 2022.

(51) Int. Cl. C08F 210/16; B01J 19/06; B01J 19/24

(52) U.S. Cl. CPC C08F 210/16; B01J 19/06; B01J 19/245; B01J 19/2455

(57) ABSTRACT

Embodiments of a dual reactor solution polymerization method comprising: introducing a first feed comprising ethylene monomer, optionally hydrogen, optionally C₃-C₁₂ alpha-olefin comonomer, and hydrocarbon solvent to a first polymerization reactor to produce via solution polymerization at a temperature from 100 to 225° C. a first reactor product comprising ethylene-based polymer; and introducing the first reactor product and a two-phase second feed comprising ethylene monomer, hydrocarbon solvent, optionally hydrogen, and optionally C₃-C₁₂ alpha-olefin comonomer to a second polymerization reactor to produce via solution polymerization ethylene-based polymer, wherein a ratio by weight of the summation of the hydrocarbon solvent plus comonomer to ethylene monomer in the two-phase second feed is from 0.1 to 2.2.

### CROSS-REFERENCE TO RELATED APPLICATIONS

This application claims priority to U.S. Provisional Application No. 63/404,744 filed Sep. 8, 2022, the entirety of which is incorporated by reference herein.

### TECHNICAL FIELD

The present specification generally relates to ethylene-based polymer, and in particular, relates to an improved polymerization process including a two-phase ethylene feed.

### BACKGROUND

Solution polymerization processes to produce ethylene-based polymer (e.g., LLDPE) utilizes hydrocarbon solvent in its reactors to carry out single, liquid-phase polymerization reactions. The solvent plays the multiple roles of dissolving the polymer and ethylene gas to provide the single, liquid-phase environment for polymerization reaction while removing some of the heat of reaction. The polymer concentration exiting the reactor section, or from another perspective, the amount of solvent used for making each product, dictates the maximum total polymer production rate as the plant throughput is limited by the total solvent devolatilization capacity of the back-end equipment. Therefore, any process improvement that leads to reduced solvent usage would help boost total plant capacity.

Conventionally, ethylene monomer is dissolved in solvent and comonomer and fed as a single, liquid-phase feed stream to ensure a consistent reactor feed, yet a single, liquid-phase feed dictates that a lot of solvent is needed to totally dissolve the fresh ethylene. As a result, the reactor polymer concentration is limited and the plant capacity is thereby also limited.

Thus, there is a continual need for improved polymerization processes that can increase output of ethylene-based polymer.

### SUMMARY

Embodiments of the present disclosure meet this need for improved output of ethylene-based polymer by applying a two-phase ethylene in solvent feed stream to feed the second reactor. Without being limited by theory, this two-phase feed injection technology raises overall polymer concentration, reduces overall solvent load, and subsequently helps boost production rate for existing dual reactor polymerization systems.

According to one embodiment, a series dual reactor solution polymerization method is provided. The dual reactor solution polymerization method comprises: introducing a first feed comprising ethylene monomer, optionally one or more C₃-C₁₂ alpha-olefin comonomer, optionally hydrogen, and hydrocarbon solvent to a first polymerization reactor to produce via solution polymerization at a temperature from 100 to 225° C. a first reactor product comprising ethylene-based polymer; and introducing the first reactor product and a two-phase second feed comprising ethylene monomer, hydrocarbon solvent, and optionally one or more C₃-C₁₂ alpha-olefin comonomer, and optionally hydrogen to a second polymerization reactor to produce via solution polymerization ethylene-based polymer, wherein a ratio by weight of the summation of the hydrocarbon solvent and comonomer to ethylene monomer in the two-phase second feed is from 0.1 to 2.2.

Additional features and advantages will be set forth in the detailed description which follows, and in part will be readily apparent to those skilled in the art from that description or recognized by practicing the embodiments described herein, including the drawings, the detailed description which follows and the claims.

### BRIEF DESCRIPTION OF THE DRAWINGS

FIG. 1 is a schematic illustration of the present series dual reactor polymerization process according to one or more embodiments of the present disclosure.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term “interpolymer” thus includes copolymers, and polymers prepared from more than two different types of monomers, such as terpolymers.

“Polyethylene” or “ethylene-based polymer” shall mean polymers comprising greater than 50% by weight of units, which have been derived from ethylene monomer. This includes polyethylene homopolymers or copolymers (meaning units derived from ethylene and one or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE”, includes resins made using Ziegler-Natta catalyst systems as well as resins made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

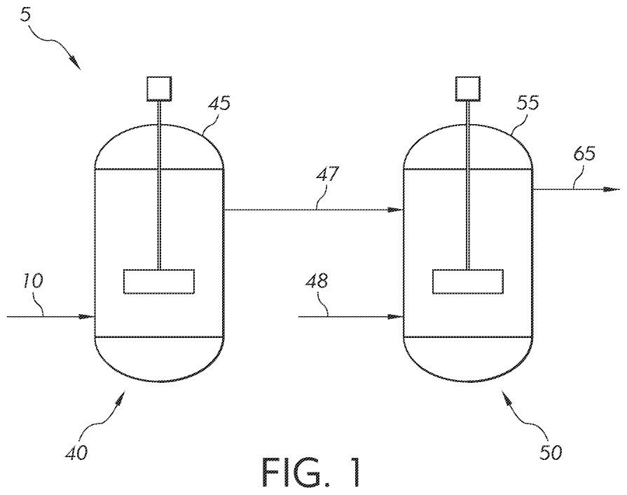

Embodiments of the present disclosure are directed to dual reactor solution polymerization systems 5 and methods as shown in FIG. 1. The method comprises introducing a first feed 10 comprising ethylene monomer, optionally one or more C₃-C₁₂ alpha-olefin comonomers, optionally hydrogen, and hydrocarbon solvent to a first polymerization reactor 40 to produce via solution polymerization at a temperature from 100 to 225° C. a first reactor product 47 comprising ethylene-based polymer. In further embodiments, the temperature may be from 100 to 205° C., 120 to 180° C., or 150 to 180° C. Subsequently, the first reactor product 47 and a two-phase second feed 48 comprising ethylene monomer, hydrocarbon solvent, optionally hydrogen, and optionally one or more C₃-C₁₂ alpha-olefin comonomers is fed to a second polymerization reactor 50 to produce via solution polymerization ethylene-based polymer 65.

The two-phase second reactor feed 48, which includes a vapor phase and liquid phase, has a ratio by weight of the summation of hydrocarbon solvent and comonomer to ethylene monomer from 0.1 to 2.2, from 0.6 to 1.6, from 0.8 to 1.2, or from 1.0 to 1.2. Without being limited by theory, a ratio by weight above 2.2 may yield a single liquid-phase feed which results in significantly lower reactor polymer concentration. In embodiments, the two-phase second feed comprises from 7 to 100 vol % of the vapor phase, or from 7 to 60 vol % of the vapor phase. In one or more embodiments, the two-phase second reactor feed may be introduced to the reactor at a temperature from 10 to 100° C., from 15 to 80° C., or from 15 to 60° C., or from 20 to 80° C., or from 20 to 60° C. Without being limited by theory, the ratio of the summation of the hydrocarbon solvent and comonomer to ethylene monomer may increase saturation temperature, thus a two-phase second reactor feed with a higher ratio (i.e., closer to 2) may correlate to higher temperatures, such as 50 to 100° C. Further without being limited by theory, a two-phase second reactor feed with a temperature at or below 100° C. enables operation with lower gelling in the reactor.

Various reactors are considered suitable for the polymerization systems 5. In one embodiment, the first polymerization reactor 40, the second polymerization reactor 50, or both comprise loop reactors. Alternatively, the first polymerization reactor 40, the second polymerization reactor 50, or both comprise continuous stirred tank reactors.

Referring again to FIG. 1, the first feed 10 may be a single phase liquid feed. In one or more embodiments, the ratio by weight of the summation of the hydrocarbon solvent and comonomer to ethylene monomer, in the first feed 10 is from above 2.2 to 10, from 4 to 8, or from 4 to 6.

Various hydrocarbon solvents are considered suitable for use in the system 5. In one or more embodiment, the hydrocarbon solvent comprises aromatic hydrocarbon solvent, aliphatic hydrocarbon solvent, or mixtures thereof

Moreover, various catalysts are considered suitable for use in the first polymerization reactor 40 and the second polymerization reactor 50. These may include Ziegler-Natta catalyst systems, single-site, and multi-site catalysts, including, but not limited to, bis-metallocene catalysts, constrained geometry catalysts, post-metallocene catalysts, molecular catalysts, bis-phenyl-phenoxy catalysts, and heterogeneous Ziegler Natta catalysts. In embodiment, the first polymerization reactor 40 may utilize a bis-phenyl-phenoxy catalyst. In other embodiments, the second polymerization reactor 50 may utilize a heterogeneous Ziegler Natta catalyst.

In additional embodiments, the polymerization system may include further polymerization reactors downstream of the first polymerization reactor 40 and the second polymerization reactor 50. These reactors may be loop reactors, continuous stirred tank reactors, pipe flow reactors, plug flow reactors, tubular reactors, or combinations thereof.

### Test Methods

### Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

### Melt Index (I₂)

Melt index, or I₂, (grams/10 minutes or dg/min) is measured in accordance with ASTM D 1238, Condition 190° C./2.16 kg, Procedure B.

### Examples

Embodiments will be further clarified by the following examples.

Six samples were produced: Comparative Example A, which included a single liquid-phase feed to the second reactor; and Inventive Examples 1-4 which included a 2-phase vapor-liquid feed to the second reactor.

Comparative Example A and Inventive Examples 1-4 were prepared, via solution polymerization, in a dual series loop reactor system according to U.S. Pat. No. 5,977,251 in the presence of a first catalyst system (CAT 1), as described in Table 1 below, in the first reactor, and a second catalyst system (CAT 2), as described in Table 1 below, in the second reactor. Inventive Example 4 was similarly prepared via solution polymerization, in a dual series loop reactor system according to U.S. Pat. No. 5,977,251 in the presence of a first catalyst system (CAT 3), as described in Table 1 below, in the first reactor, and a second catalyst system (CAT 4), as described in Table 1 below, in the second reactor.

| | |
|---|---|
| CAT 1 | 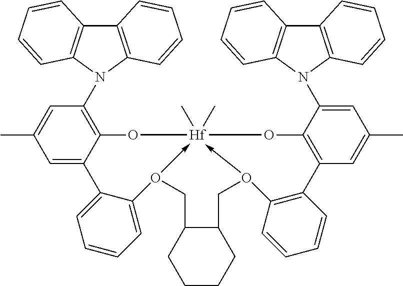 |
| | bis((2-oxoy1-3-(dibenzo-1H-pyrrole-1-yl)-5-(methyl)phenyl)-2-phenoxymethyl)-methylene-1,2- |
| | cyclohexanediylhafnium (IV) dimethyl |
| CAT 2 | Ziegler-Natta type catalyst (CAT 2). The heterogeneous Ziegler-Natta type catalyst-premix was |
| | prepared substantially according to U.S. Pat. No. 4,612,300, by sequentially adding to a volume |
| | of ISOPAR E, a slurry of anhydrous magnesium chloride in ISOPAR E, a solution of EtAlCl₂ in |
| | heptane, and a solution of Ti(O-iPr)4 in heptane, to yield a composition containing a magnesium |
| | concentration of 0.20M, and a ratio of Mg/Al/Ti of 40/12.5/3. An aliquot of this composition was |
| | further diluted with ISOPAR-E, to yield a final concentration of 500 ppm Ti in the slurry. While |
| | being fed to, and prior to entry into, the polymerization reactor, the catalyst premix was contacted |
| | with a dilute solution of Et₃Al having a molar Al to Ti ratio of 4.0 to give the active catalyst. |
| CAT 3 | 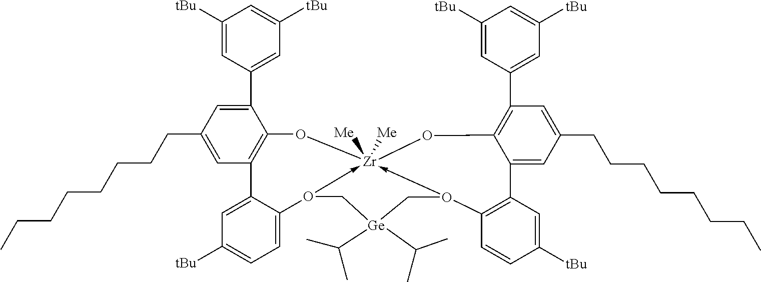 |
| CAT 4 | 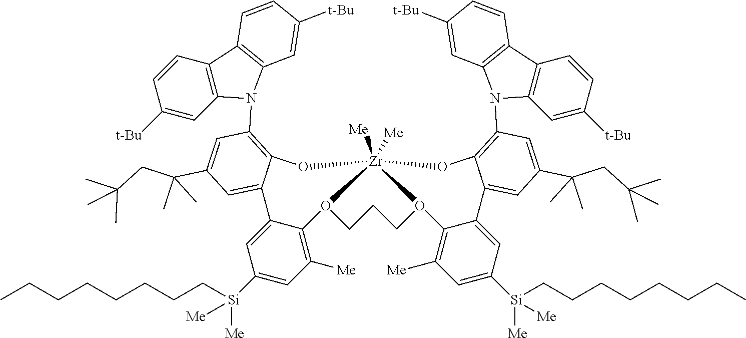 |
| Cocat1 | Bis(hydrogenated tallow alkyl)methyl, tetrakis(pentafluorophenyl)borate(1-)amine |
| Cocat2 | modified methyl aluminoxane (MMAO) |

In Comparative Example A (left column of Table 2), the 2^{nd} reactor solvent plus comonomer to ethylene ratio of 2.4 was applied to remain single liquid phase feed at 40° C. feed temperature.

TABLE 2

| Reactor | | Comparative | Inventive | Inventive | Inventive | Inventive |
|---|---|---|---|---|---|---|
| Conditions | Units | Example A | Example 1 | Example 2 | Example 3 | Example 4 |
| 1^{st} Reactor Feed | ° C. | 40 | 40 | 30 | 30 | 50 |
| Temperature | | | | | | |
| 1^{st} Reactor | ° C. | 160 | 160 | 160 | 160 | 160 |
| Temperature | | | | | | |
| 1^{st} Reactor | n/a | 1-octene | 1-octene | 1-octene | 1-octene | 1-octene |
| Comonomer | | | | | | |
| 1^{st} Reactor | n/a | CAT3 | CAT3 | CAT1 | CAT1 | CAT3 |
| Catalyst | | | | | | |
| 1^{st} Reactor | n/a | Cocat1 | Cocat1 | Cocat1 | Cocat1 | Cocat1 |
| Co-Catalyst(s) | | Cocat2 | Cocat2 | Cocat2 | Cocat2 | Cocat2 |
| 1^{st} Reactor | lbs/lbs | 5.4 | 5.6 | 7.2 | 7.2 | 7.3 |
| (Solvent + | | | | | | |
| Comonomer)/ | | | | | | |
| Ethylene Ratio | | | | | | |
| 2^{nd} Reactor Feed | ° C. | 40 | 40 | 81 | 98 | 15 |
| Temperature | | | | | | |
| 2^{nd} Reactor | ° C. | 205 | 205 | 195 | 195 | 205 |
| Temperature | | | | | | |
| 2^{nd} Reactor | n/a | CAT4 | CAT4 | CAT2 | CAT2 | CAT4 |
| Catalyst & | | Cocat1 | Cocat1 | | | Cocat1 |
| Co-Catalyst(s) | | Cocat2 | Cocat2 | | | Cocat2 |
| 2^{nd} Reactor | lbs/lbs | 2.40 | 1.23 | 0.24 | 0.12 | 1.65 |
| (Solvent + | | | | | | |
| Comonomer)/ | | | | | | |
| Ethylene Ratio | | | | | | |
| 2^{nd} Reactor | Psig | 725 | 500 | 725 | 725 | 500 |
| Operating | | | | | | |
| Pressure | | | | | | |
| 2nd Reactor | % | 0.1 | 86.2 | 97.9 | 100 | 55 |
| Feed Volume | | | | | | |
| Vapor Percent | | | | | | |
| Actual Solvent | % | 100 | 100 | 100 | 100 | 100 |
| Flow/Maximum | | | | | | |
| Solvent flow | | | | | | |
| Production | % | 0 | 9.5 | 14.0 | 15.9 | 10.5 |
| Rate Change % | | | | | | |
| vs Design | | | | | | |
| Capacity | | | | | | |
| Overall Melt | g/10 | 0.82 | 0.85 | 0.89 | 0.89 | 0.85 |
| Index (I₂) | mins | | | | | |
| Overall | g/cc | 0.925 | 0.925 | 0.918 | 0.918 | 0.928 |
| Density | | | | | | |
| Overall I₁₀/I₂ | n/a | 7.1 | 7.7 | 8.4 | 7.9 | 8.3 |

In contrast, Inventive Example 1 applied a lower 2^{nd} reactor solvent plus comonomer to ethylene ratio of 1.23, which put the 2^{nd} reactor feed in the 2-phase vapor-liquid regime. This yielded a production rate increase by 9.500 compared to the Comparative Example A design capacity, which was not increased. Meanwhile, the total solvent amount needed for the 2-phase feed recipe was still within the maximum total solvent processing constraint. Inventive Examples 2-4, which also had a second reactor solvent to ethylene ratio of 2.2 or less, also demonstrated an improved production rate compared to the Comparative Example A design capacity.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A dual reactor solution polymerization method comprising:
introducing a first feed comprising ethylene monomer, optionally one or more C₃-C₁₂ alpha-olefin comonomers, optionally hydrogen, and hydrocarbon solvent to a first polymerization reactor to produce, via solution polymerization at a temperature from 100 to 225° C., a first reactor product comprising ethylene-based polymer; and
introducing the first reactor product and a two-phase second feed, wherein the two-phase second feed temperature is 10° C. to 100° C., and comprising ethylene monomer, hydrocarbon solvent, optionally hydrogen, and optionally one or more C₃-C₁₂ alpha-olefin comonomers to a second polymerization reactor to produce via solution polymerization ethylene-based polymer, wherein a ratio by weight of the summation of the hydrocarbon solvent and comonomer to ethylene monomer in the two-phase second feed is from 0.1 to 2.2.

2. The method of claim 1, wherein the ratio by weight of the summation of the hydrocarbon solvent and comonomer to ethylene monomer in the two-phase second feed is from 0.6 to 1.6.

3. The method of claim 1, wherein the two-phase second feed comprises a liquid phase and vapor phase.

4. The method of claim 2, wherein the two-phase second feed comprises from 7 to 98 vol % of the vapor phase.

5. The method of claim 1, wherein the two-phase second feed comprises C₃-C₁₂ alpha-olefin comonomer.

6. The method of claim 1, wherein the first polymerization reactor, the second polymerization reactor, or both comprise loop reactors.

7. The method of claim 1, wherein the first feed is a single phase liquid feed.

8. The method of claim 1, wherein a ratio by weight of the summation of the hydrocarbon solvent and comonomer to ethylene monomer in the first feed is from greater than 2.2 to 10.

9. The method of claim 1, wherein the hydrocarbon solvent comprises aromatic hydrocarbon solvent, aliphatic hydrocarbon solvent, or mixtures thereof.

10. An ethylene based polymer produced from the method of claim 1.
